(19) United States
(12) Patent Application Publication
(10) Pub. No.: US 2012/0132840 A1
(43) Pub. Date: May 31, 2012

(54) NEEDLE VALVE

(75) Inventors: Jeff Shuman, Edinboro, PA (US); Kent Hemme, Fairview, PA (US); Jason Anderson, Girard, PA (US)

(73) Assignee: INNOVATIVE PRESSURE TECHNOLOGIES, Erie, PA (US)

(21) Appl. No.: 13/181,759

(22) Filed: Jul. 13, 2011

Related U.S. Application Data
(60) Provisional application No. 61/364,618, filed on Jul. 15, 2010.

(51) Int. Cl. F16K 31/60

(52) U.S. Cl. 251/264

(57) ABSTRACT

A needle valve includes a body, a needle assembly sized to be received in the body, and a handle sized to move the needle assembly relative to the body. A captive screw may be provided and is sized to mount the handle to the needle assembly. Further, a packing gland may be provided and is sized to be received in the body and sized to cover a portion of the needle assembly. An inert material, such as a nylon patch, is applied to a portion of the packing gland to lock the packing gland within the body. The needle valve could include a two piece, non-rotating stem.

### RELATED APPLICATION

The present application is related to and claims priority to U.S. Provisional Patent Application No. 61/364,618 filed on Jul. 15, 2010, the entire contents of which are incorporated herein by reference.

### FIELD OF THE INVENTION

The present invention relates to flow control valves, and more particularly, to needle valves.

### BACKGROUND OF THE INVENTION

Needle valves have been used for many years to control the flow of fluids. In particular, needle valves are used in a variety of applications where precision and accuracy are necessary to control the flow of fluids. In its simplest form, a needle valve includes a body with a valve seat, and a needle assembly receivable in the valve seat. A handle may be provided to move the needle assembly relative to the valve seat. As the needle assembly moves relative to the valve seat, the flow of a fluid may be controlled.

The handles are typically attached to the needle assembly by a conventional screw. These conventional screws may be misplaced or lost during the assembly or disassembly of the handle.

Conventional needle valves may include a packing gland to prevent the leakage of fluid from the body. A mechanical locking device, such as a locking washer, is employed on top of the body to inhibit the packing gland from rotating.

### SUMMARY OF THE INVENTION

The present invention relates to a needle valve that includes a body, a needle assembly sized to be received in the body, and a handle sized to move the needle assembly relative to the body. In one exemplary embodiment, a captive screw is provided and is sized to mount the handle to the needle assembly. The captive screw and the handle are configured to prevent removal of the captive screw from the handle when the handle is disassembled from the needle assembly. Further, a packing gland is provided and is sized to be received in the body and sized to cover a portion of the needle assembly. An inert material, such as a nylon patch, is applied to a portion of the packing gland to lock the packing gland within the body. The needle valve could include a two piece, non-rotating stem.

### BRIEF DESCRIPTION OF THE DRAWINGS

The foregoing and other objects, aspects, features, and advantages of exemplary embodiments will become more apparent and may be better understood by referring to the following description taken in conjunction with the accompanying drawings, in which:

FIG. 1 illustrates a perspective view of an exemplary needle valve;

FIG. 2 is a cross-sectional view, taken along section lines 2-2, and looking in the direction of the arrows, of the exemplary needle valve of FIG. 1;

FIG. 3 is a perspective view of a packing gland with an integral locking feature;

FIG. 4 is a front view of the packing gland of FIG. 3;

FIG. 5 is an exploded view of a handle and a captive screw assembly;

FIG. 6 is a perspective view of the handle with the captive screw assembly in an installed position;

FIG. 7 is a cross-sectional view of the handle with the captive screw assembly in an installed position;

FIG. 8 is a cross-sectional view of the handle with the captive screw assembly in a loose but captive position;

FIG. 9 is a cross-sectional view of the handle with the captive screw assembly in a loose but captive position;

FIG. 10 is a cross-sectional view of the handle with the captive screw assembly in an installed position; and

FIG. 11 is a cross-sectional view of the handle with the captive screw assembly in an installed position.

### DETAILED DESCRIPTION

The exemplary embodiments taught herein are described in connection with a needle valve that allows precise regulation of fluid flow. It should be understood, however, that the teachings herein can be used with other types of valves.

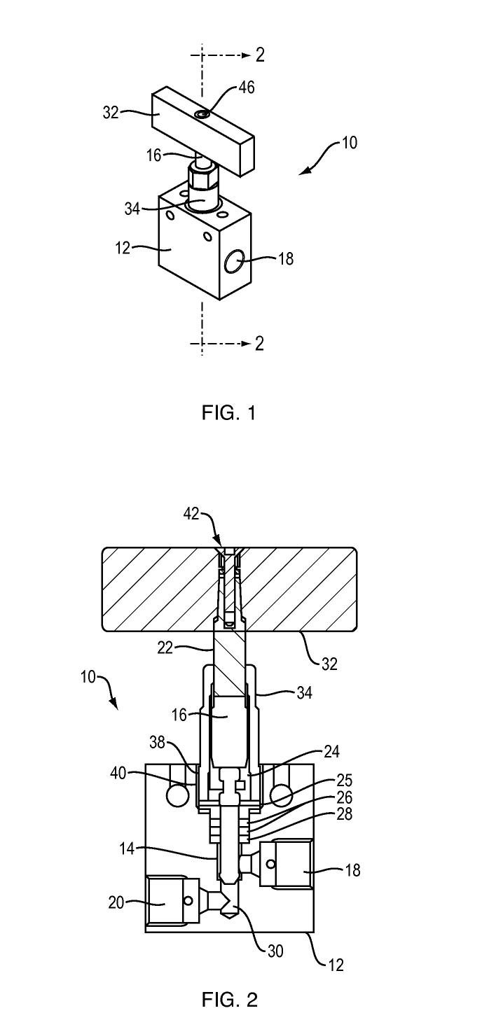

FIGS. 1 and 2 illustrate an exemplary embodiment of a needle valve of the present invention. The needle valve, designated generally as 10, includes a valve body 12 with a valve seat 14 (FIG. 2), and a needle assembly 16 receivable in the valve seat 14. The needle valve 10 has a first port 18 and a second port 20 (see FIG. 2), each of which allowing for bi-directional flow capability. A flow path for the fluid being controlled is present between the two ports 18, 20 passing through the valve seat 14. While two ports 18, 20 are shown, it will be understood that the number and arrangement of ports could vary and the ports could be either inlet ports, outlet ports, or bi-directional ports. For example, the needle valve 10 could be a three-way valve, which could employ three ports.

As illustrated in FIG. 2, the needle assembly 16 includes an upper stem 22 and a non-rotating lower stem 24 attached to the upper stem 22 such that the upper stem 22 is movable conjointly with the lower stem 24. The lower stem 24 is secured through a top packing washer 25, a packing ring 26, and a bottom packing washer 28 received in the valve seat 14 of the body 12. A stem tip 30 is attached to or formed at the lower stem 24. A handle 32 is securable to the upper stem 22, as will be described in further detail hereinafter. The handle 32 may be provided to move the needle assembly 16 relative to the valve seat 14.

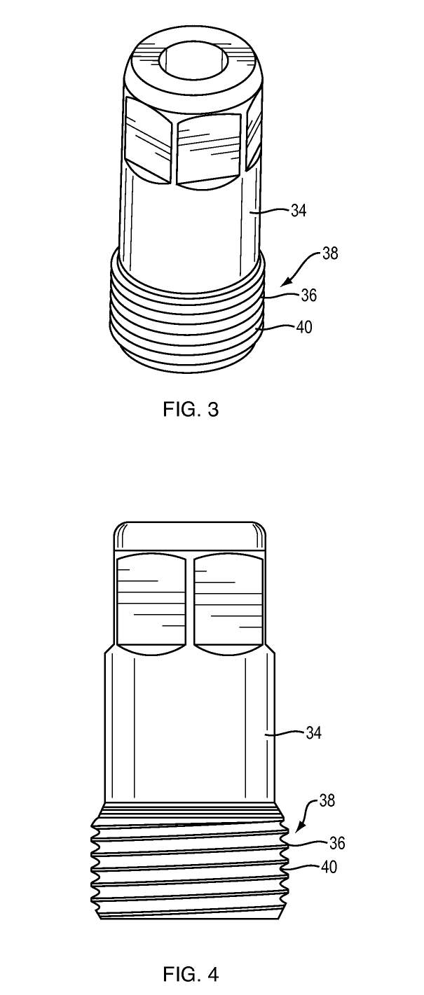

A packing gland 34 (see FIGS. 3 and 4) covers a portion of the needle assembly 16 (see FIG. 2) to prevent the leakage of fluid from the valve body 12 (see FIG. 2). Referring to FIG. 4, a lower end 36 of the packing gland 34 includes a series of external threads 38 sized to engage the valve body 12.

In one exemplary embodiment, a portion of the external threads 38 of the packing gland 34 is coated with a lock material 40, such as an inert patch, as shown in FIG. 4. The lock material 40 serves to lock the packing gland 34 to the valve body 12 and prevents the packing gland 34 from rotating once mated to the valve body 12. The lock material 40 also prevents the packing gland 34 from loosening and leakage of fluid from the valve body 12. The lock material 40 is designed to provide a breakaway torque for the packing gland 34 such that the packing gland 34 seals at the interface between the packing gland 34 and the valve body 12.

In one exemplary embodiment of the coating process, the portion of the external threads 38 of the packing gland 34 is heated to a selected temperature, and the lock material is sprayed or fused to the heated portion. A die can be used to match the lock material 40 with the external threads 38 of the packing gland 34. After the lock material 40 is coated onto the portion of the packing gland 34, the lock material 40 is compressed. The compression of the lock material 40 could create a constant spring-like pressure between the portion of the external threads 38 and the valve body 12. The resilience of the lock material 40 retains the packing gland 34 in place without the use of adhesives or thread distortion.

In one exemplary embodiment, the lock material 40 could be positioned onto three threads from the end of the packing gland 34, and the coating length could be four to six threads. In another embodiment, the lock material 40 may extend in a radial direction between a range of 90° and 360°. While the lock material 40 is applied to the portion of the external threads 38 of the packing gland 34, the lock material 40 could be applied to all of the external threads 38. In some embodiments, the lock material 40 is configured as a vertical strip that extends across one or more threads in a direction perpendicular to the external threads 38.

The lock material 40 could be a thermoplastic material, a nylon material, a nylon/polymer material, or any other suitable commercially available materials. An example of a suitable commercially available lock material 40 is a ND Patch® Hi-Temp Lock Patch manufactured by ND Industries, based in Michigan.

Referring to FIG. 5, the handle 32 is secured to the needle assembly 16 by a captive screw assembly 42 received in an aperture 44 formed in the top of the handle 32 and extending through the bottom of the handle 32 in one exemplary embodiment. The captive screw assembly 42 includes a captive screw 46 having a shaft 48 with a threaded section 50 that has a larger diameter than the shaft 48, and a head section 52. A spring 54 is sized to encircle the captive screw 46. A retaining device, such as a split ring 56, is sized to retain the captive screw 46. The split ring 56 has a smaller diameter than the threaded section 46 of the captive screw 46. An o-ring could be employed in conjunction with the split ring 56 or in place of the split ring 56.

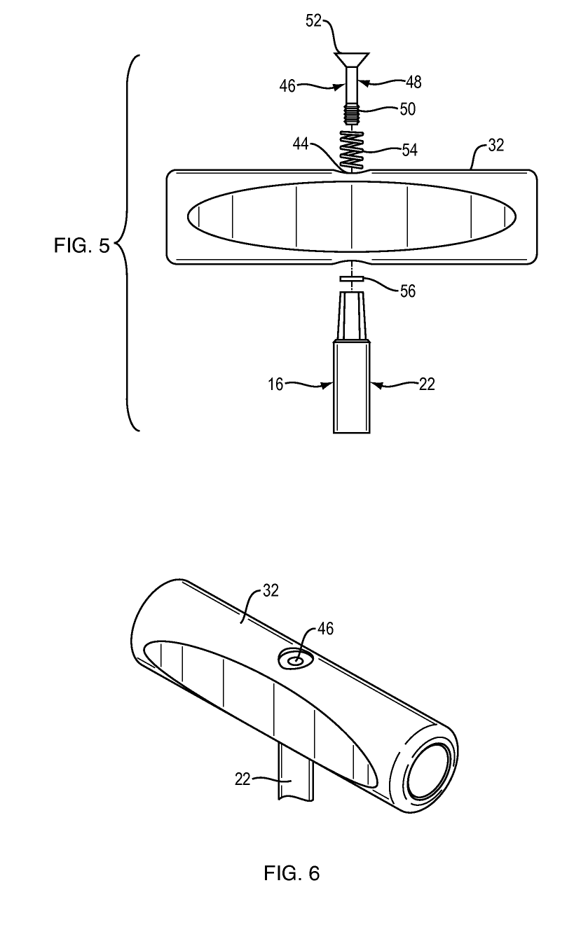

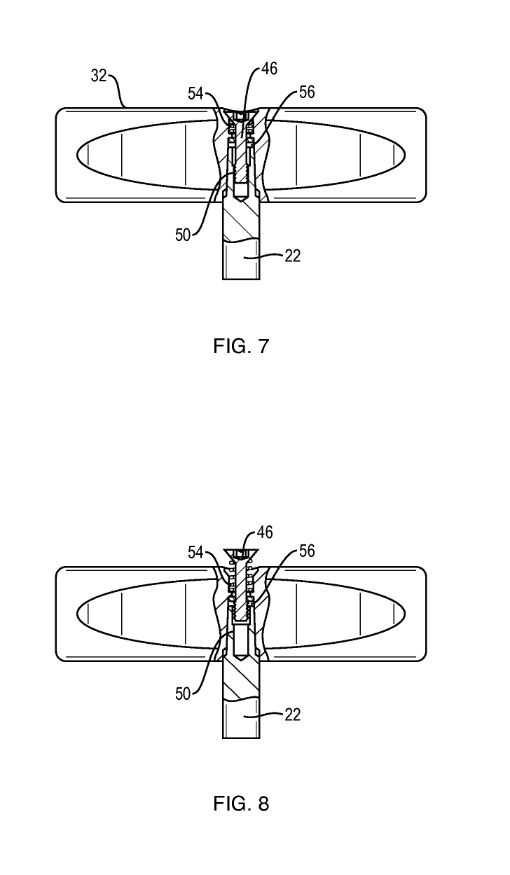

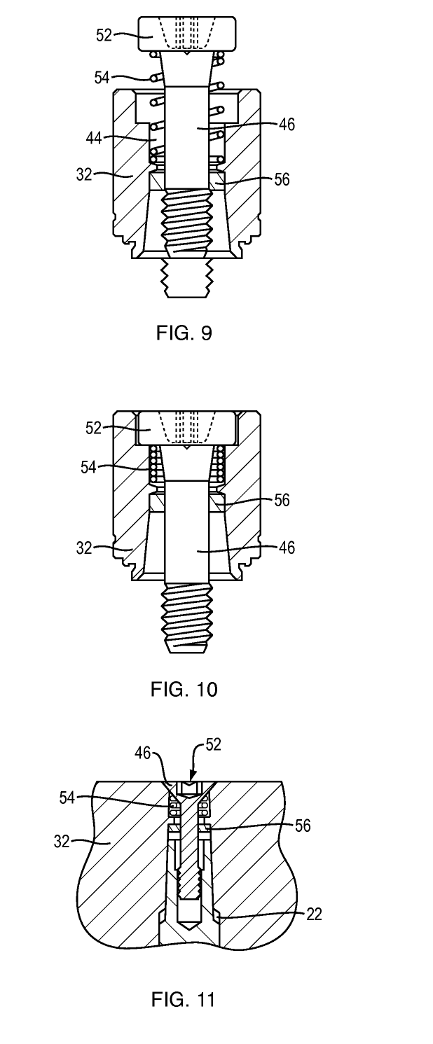

The captive screw 46 is configured to move between an installed position, as shown in FIGS. 6, 7, 10, and 11, and a loose, but captive position, as shown in FIGS. 8 and 9. To install the captive screw 46, the captive screw 46 is inserted into the aperture 44 formed in the handle 32 in one direction until the threaded section 50 and a portion of the shaft 48 pass through the split ring 56. The split ring 56 then closes. Because the split ring 56 has a smaller diameter than the threaded section 50 of the captive screw 46, the threaded section 50 is prevented from passing through the closed split ring 56 in the opposite direction. This allows the captive screw 46 to be retained in the handle 32. The threaded section 50 of the captive screw 46 threadedly engages and mates with the upper stem 22 of the needle assembly 16.

When the captive screw 46 is loosened or disassembled, as shown in FIGS. 8 and 9, the spring 54 biases the captive screw 46 in an upwardly direction such that the head section 52 protrudes from the handle 32. The retaining split ring 56 serves to retain the captive screw 46 within the handle 32 when the head section 52 protrudes from the handle 32. In this manner, the captive screw 46 does not separate from the handle 32 after the captive screw 46 is loosened, thereby preventing the captive screw 46 from being misplaced or dropped during installation or repair.

The captive screw 46 could be made from any material, such as stainless steel. Likewise, the handle 32 could be made from any material, such as stainless steel.

The needle valve 10 could be utilized in a variety of applications, such as offshore oil and gas, water jet cutting, general plant service, instrument isolation, hydraulic applications, pneumatic applications, pressure measurement devices, and venting. The working pressure could be in a range from about 5,000 PSI to 150,000 PSI.

It will be understood that the embodiments described herein are merely exemplary and that a person skilled in the art may make many variations and modifications without departing from the spirit and scope of the invention. All such variations and modifications are intended to be included within the scope of the invention as defined by the appended claims.

What is claimed is:

1. A needle valve, comprising:
a body;
a needle assembly sized to be received in said body;
a packing gland sized to be received in said body and sized to cover a portion of said needle assembly; and
an inert material applied to a portion of the packing gland to lock said packing gland within said body.

2. The needle valve of claim 1, wherein said inert material comprises a thermoplastic material.

3. The needle valve of claim 2, wherein said thermoplastic material comprises a nylon material.

4. The needle valve of claim 3, wherein said inert material comprises a nylon and polymer material.

5. The needle valve of claim 1 further comprising,
a handle sized to move said needle assembly relative to said body; and
a captive screw sized to mount said handle to said needle assembly, said captive screw and said handle configured to retain said captive screw in said handle when said handle is disassembled from said needle assembly.

6. The needle valve of claim 1, wherein said needle assembly comprises an upper stem and a non-rotating lower stem attached to said upper stem.

7. The needle valve of claim 1 further comprising, at least one port sized to allow bi-directional flow.
